(19) United States
(12) Patent Application Publication
(10) Pub. No.: US 2016/0195336 A1
(43) Pub. Date: Jul. 7, 2016

(54) HONEYCOMB HEAT EXCHANGER

(71) Applicant: Hamilton Sundstrand Corporation, Charlotte, NC (US)

(72) Inventors: Leo J. Veilleux, JR., Wethersfield, CT (US); Lubomir A. Ribarov, West Hartford, CT (US)

(21) Appl. No.: 14/591,215

(22) Filed: Jan. 7, 2015

(51) Int. Cl. F28D 7/00; F28F 9/02; F28F 1/04; B23P 15/26; F28F 1/02

(52) U.S. Cl. CPC F28D 7/0025; B23P 15/26; F28F 1/022; F28F 1/045; F28F 9/0253

(57) ABSTRACT

A heat exchanger has a plurality of cells. A first subset of the cells extends for a lesser distance along an axis of the cells and a second subset of the cells extends for a greater axial distance. The second subset of cells extends through separator plates which are positioned beyond axial ends of the first subset of cells. A method is also disclosed.

### BACKGROUND OF THE INVENTION

This application relates to a heat exchanger wherein a honeycomb structure is utilized.

Heat exchangers are known and include any number of structures wherein two fluids are passed across adjacent surfaces such that one fluid can transmit heat away from the other. Example heat exchangers may be utilized in refrigeration cycles, air cycle machines for aircraft applications, and any number of other industrial applications.

In general, one of the fluids, which could be called a heat accepting fluid, accepts heat from the other, which could be called a heat rejecting fluid.

It has been proposed to utilize honeycomb structures including a plurality of cells extending along an axial dimension as part of heat exchangers. However, in general, all of the cells receive either the heat rejecting fluid or the heat accepting fluid.

Also, honeycomb structures are difficult to manufacture.

Recently, so-called additive manufacturing techniques have been developed to manufacture components. However, additive manufacture techniques have not been utilized to form honeycomb structures for heat exchanger cores.

### SUMMARY OF THE INVENTION

A heat exchanger has a plurality of cells. A first subset of the cells extends for a lesser distance along an axis of the cells and a second subset of the cells extends for a greater axial distance. The second subset of cells extends through separator plates which are positioned beyond axial ends of the first subset of cells. A first inlet manifold is defined between a first inlet one of the separator plates and one axial end of the first subset of cells and a first outlet manifold is defined between a first outlet one of the separator plates and an axial end of the first subset of cells. A second inlet manifold is defined between one axial end of the second subset of cells and a second outlet one of the one separator plates. A second outlet manifold is defined beyond a second outlet one of the separating plates and a second axial end of the second subset of cells. A heat rejecting fluid will pass for passing through one of the first and second subset of cells. A heat accepting fluid will pass through the other of the first and second subset of cells. A method is also disclosed.

These and other features may be best understood from the following drawings and specification.

### BRIEF DESCRIPTION OF THE DRAWINGS

FIG. 1 shows a heat exchanger.

FIG. 2 is a cross-sectional view along line 2-2 of FIG. 1.

FIG. 3 is a cross-sectional view along line 3-3 of FIG. 1.

FIG. 4 is a perspective view of a honeycomb structure.

FIG. 5 shows an intermediate step in the formation of a honeycomb structure using additive manufacturing techniques.

### DETAILED DESCRIPTION

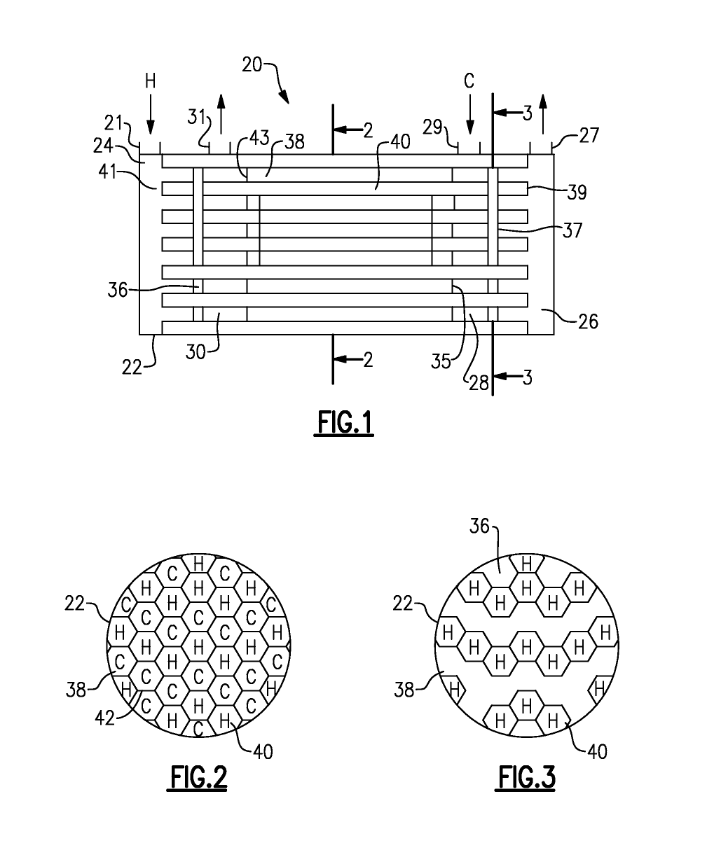

A heat exchanger 20 is illustrated in FIG. 1 having an outer housing 22. A heat rejecting, or hot fluid H enters a port 21 into an inlet manifold 24. This fluid passes through cells 40 in a honeycomb structure to an outlet manifold 26 and then leaves an outlet port 27. Heat accepting, or cold fluid C, enters an inlet manifold 28 through a port 29, passes through honeycomb cells 38, enters an outlet manifold 30 and leaves through outlet port 31.

End or separator plates 36 and 37 separate the manifolds 24 and 30, and 28 and 26, respectively. As can be appreciated, the cells 40 extend axially between an inlet end 41 and an outlet end 39, which are each beyond the separating plates 36/37. Conversely, the cells 38 extend between an inlet end 35 and an outlet end 43, which are inward of the separating plates 36/37.

As shown in FIG. 2, the cells 38 and 40 are interspersed with each other, and defined by a plurality of separating walls 42. In the illustrated embodiment, the majority of the honeycomb cells have six sides. It should be understood that other shapes could be provided for the cells. In general, a majority of the cells may have at least three sides. Still, curved shapes, and even circular cross-sections may be used. Also, the cells need not all have the same shape due to the overall heat exchanger's core geometry and architecture.

As can be appreciated, the majority of the cells have walls 42 contacting walls of at least two cells of the other type. That is, the majority of the cells 38 have at least two sides or walls 42 contacting a cell 40, and the majority of the cells 40 have at least two sides contacting a cell 38. In the illustrated embodiment, all of the cells 38 and 40 have at least two sides contacting the other type cell.

Heat exchanger 20 could be described as having a plurality of cells with a first subset 38 of the cells extending for a lesser distance along an axis of the cells and a second subset 40 of the cells extending for a greater axial distance. The second subset of cells 40 extends through two separator plates 36/37 which are positioned beyond axial ends 35/43 of the first subset of cells. A first inlet manifold 28 is defined between a first inlet one 37 of the two separator plates and one axial end 35 of the first subset of cells. A first outlet manifold 30 is defined between a first outlet one 36 of the two separator plates and a second axial end 43 of the first subset of cells. A second inlet manifold 24 is defined beyond a second inlet one 36 of the two separator plates. A second outlet manifold 26 is defined beyond a second outlet one 37 of the two separator plates. A heat rejecting fluid passes through one of the first and second subset of cells. A heat receiving fluid passes through the other of the first and second plurality of cells.

In the disclosed embodiment, the first inlet one 37 of the two separator plates and the second inlet one 36 of the two separator plates are different such that the heat rejecting fluid and the heat accepting fluid will flow in counter-flow relationship. However, this disclosure extends to embodiments where the fluids flow in the same direction.

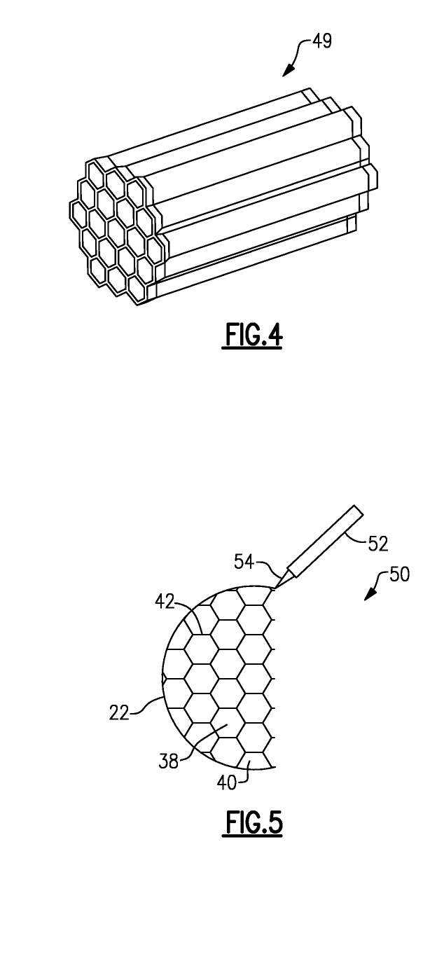

FIG. 3 shows a separating plate 36. As shown, the cells 40 receiving the hot or heat rejecting fluid H extend through the separating plates 36, while the portions aligned with the cells 38 are closed off by plate 36. Of course, this could be reversed with the heat rejecting fluid H extending for the shorter axial length.

Manifolds 28 and 30 are opened around the cells 40 such that they communicate with parts 29 and 31.

Plate 37 would be similarly structured.

FIG. 4 is a perspective view of a structure 49 which may approximate that utilized in the heat exchanger 20.

Of course, the structure 49 illustrated in FIG. 4 has the cells extending for the same axial length and, thus, it would not be identical to the structure shown in FIG. 1. Still, the Figure does provide a perspective.

The structure shown in FIG. 1 may be challenging to manufacture. The structure shown in FIG. 4 is actually challenging to manufacture, but having the different length cells and separator plates would be even more challenging.

FIG. 5 shows an intermediate step 50 in the formation of the cells 38 and 40 as illustrated in FIG. 1 by forming walls 42. As shown, a plurality of cells 38 and 40 have been defined by a plurality of wall segments 42. An additive manufacturing tool 52 is shown spraying material 54 to form additional walls. The tool 52 also forms outer housing 22. Tool 52 will also form plates 36/37. As known, the formation occurs in layers.

Additive manufacturing techniques are known and are also known as 3-D printing, or a number of other names. In essence, they are computer controlled processes which put down material in layers to form complex shapes.

A heat exchanger, as illustrated in FIG. 1, would be readily manufacturable by additive manufacturing techniques.

A method of forming a heat exchanger 20 includes the steps of using additive manufacturing to form a honeycomb structure from a plurality of cells, with a first subset of cells 38 extending for a lesser distance along an axis of the cells and a second subset of cells 40 extending for a greater axial distance. The second subset of cells 40 extends through separator plates 37/36 which are formed beyond axial ends 35/43 of the first subset of cells 38. A first inlet manifold 28 is formed between separator plate 37 and axial end 35 of first subset of cells 38. A first outlet manifold 30 is formed between separator plate 36 and a second axial end 43 of the first subset of cells 38. A second inlet manifold 24 is formed beyond separator plate 36, and a second outlet manifold 26 is formed beyond separator plate 37.

Although an embodiment of this invention has been disclosed, a worker of ordinary skill in this art would recognize that certain modifications would come within the scope of this invention. For that reason, the following claims should be studied to determine the true scope and content of this invention.

1. A heat exchanger comprising:
a plurality of cells with a first subset of said cells extending for a lesser distance along an axis of said cells and a second subset of said cells extending for a greater axial distance, with said second subset of cells extending through two separator plates which are positioned beyond axial ends of said first subset of cells, and a first inlet manifold defined between a first inlet one of said two separator plates and one axial end of said first subset of cells, and a first outlet manifold defined between a first outlet of said two separator plates and a second axial end of said first subset of cells, and a second inlet manifold defined beyond a second inlet one of said two separator plates and a second outlet manifold defined beyond a second outlet one of said two separator plates, with a heat rejecting fluid for passing through one of said first and second subset of cells, and a heat receiving fluid for passing through the other of said first and second plurality of cells.

2. The heat exchanger as set forth in claim 1, wherein a majority of said cells have at least three sides.

3. The heat exchanger as set forth in claim 2, wherein said first subset of cells and said second subset of cells each have a majority of their cells contacting the other of said first and second subset of cells on at least two of said at least three sides.

4. The heat exchanger as set forth in claim 3, wherein a majority of said cells have six sides.

5. The heat exchanger as set forth in claim 3, wherein said first inlet one of said two separator plates and said second inlet one of said two separator plates are different ones of said two separator plates such that said heat rejecting fluid and said heat accepting fluid will flow in counter-flow relationship.

6. The heat exchanger as set forth in claim 5, wherein said heat exchanger is formed by additive manufacturing processes.

7. The heat exchanger as set forth in claim 1, wherein a majority of said cells have six sides.

8. The heat exchanger as set forth in claim 7, wherein said first inlet one of said two separator plates and said second inlet one of said two separator plates are different ones of said two separator plates such that said heat rejecting fluid and said heat accepting fluid will flow in counter-flow relationship.

9. The heat exchanger as set forth in claim 1, wherein said first inlet one of said two separator plates and said second inlet one of said two separator plates are different ones of said two separator plates such that said heat rejecting fluid and said heat accepting fluid will flow in counter-flow relationship.

10. The heat exchanger as set forth in claim 1, wherein said heat exchanger is formed by additive manufacturing processes.

11. A method of forming a heat exchanger comprising the steps of:
using additive manufacturing to form a honeycomb structure from a plurality of cells, with a first subset of said cells extending for a lesser distance along an axis of said cells and a second subset of said cells extending for a greater axial distance, with said second subset of cells extending through two separator plates which are formed beyond axial ends of said first subset of cells, and a first inlet manifold formed between a first inlet one of said separator plates and one axial end of said first subset of cells, and a first outlet manifold formed between a first outlet one of said two separator plates and a second axial end of said first subset of cells, and a second inlet manifold formed beyond a second inlet one of said two separator plates and a second outlet manifold formed beyond a second outlet one of said two separator plates.

12. The method as set forth in claim 11, wherein a majority of said cells have at least three sides.

13. The method as set forth in claim 12, wherein said first subset of cells and said second subset of cells each have a majority of said cells contacting the other of said first and second subset of cells on at least two of said at least three sides.

14. The method as set forth in claim 12, wherein a majority of said cells are formed to have six sides.

15. The method as set forth in claim 11, wherein said first inlet one of said two separator plates and said second inlet one of said two separator plates are different ones of said two separator plates such that said heat rejecting fluid and said heat accepting fluid will flow in counter-flow relationship.
